(19) United States
(12) Patent Application Publication
(10) Pub. No.: US 2011/0225019 A1
(43) Pub. Date: Sep. 15, 2011

(54) SEARCH, ANALYSIS AND CATEGORIZATION

(76) Inventors: David Taylor, Ballarat North (AU); Benjamin Lehman, Myrtle Bank (AU); Duncan Bucknell, Eltham (AU)

(21) Appl. No.: 13/123,899

(22) PCT Filed: Oct. 14, 2009
(86) PCT No.: PCT/AU2009/001352

§ 371 Date: Apr. 12, 2011

Related U.S. Application Data
(60) Provisional application No. 61/166,272, filed on Apr. 3, 2009.

(30) Foreign Application Priority Data
Oct. 14, 2008 (AU) 2008905318
Jan. 23, 2009 (AU) 2009900274
Feb. 24, 2009 (AU) 2009900791

(51) Int. Cl. G06Q 10/00; G06Q 50/00; G06Q 99/00

(52) U.S. Cl. 705/7.28; 705/310; 705/318; 705/7.36; 705/7.29

(57) ABSTRACT

A method of categorizing a brand comprising the steps of: (i) Collecting a brand-related search term from a user via an interface; (ii) Scanning a computer network (optionally the Internet) for data containing the brand; (iii) Scanning one or more pre-selected data sources for data containing the brand; (iv) Returning search results from the two said scanning steps; (v) Comparing the search results with a set of keywords associated with one or more predetermined categories; (vi) Suggesting one or more categories for the brand based on the results of the keyword search; (vii) Ranking the suggested categories in order of relevance to the brand;

### FIELD OF THE INVENTION

The present invention relates to systems and processes for search, analysis and categorization in relation to brands.

### BACKGROUND TO THE INVENTION

There are many instances in which it is useful to search for, analyse and/or categorise a brand. For example, in order to identity an appropriate classification for the entity, goods or services associated with the brand, to categorise an entity which has the brand as its name, to search for and analyse uses of the brand by the owner or a third party, to provide for automatic filling of forms or creation of documents, and so on. There is a need for a more efficient system and processes to these ends.

The term ‘brand’ and its (grammatical variations) is not intended to be used in a limited sense herein. It refers to the name of any thing which is intended to have a specific relationship with an entity. Thus, brands may for example cover entity names, good or service names and the like.

The term ‘entity’ as used herein may be of any suitable type including a natural person, an organisation, a company, an association, and so on.

### SUMMARY OF THE INVENTION

In one aspect at the invention, there is provided a method for generating a keyword about a brand comprising: receiving at least one element of basic data and using the basic data to generate a keyword.

In another aspect or the invention, there is provided a method for categorising a brand comprising:
collecting a keyword;
optionally expanding the collected keyword;
optionally ranking the collected keyword against another collected keyword;
collecting a category relevant to the keyword;
optionally ranking the category against another relevant category;

In another aspect of the invention, there is provided a method for creating an application comprising a method for generating a keyword and/or a method for categorising a brand and optionally the step of creating an at least partially filled form or document.

In another aspect of the invention, there is provided a method for filling a form or creating a document comprising a method for generating a keyword and/or a method for categorising a brand.

In another aspect of the invention, there is provided a method for preparing an application for protection of a brand comprising a method for generating a keyword and/or a method for categorising a brand.

In another aspect of the invention, there is provided a method of performing a brand protection gap analysis comprising a method for generating a keyword and/or a method for categorising a brand.

In another aspect of the invention, there is provided a method for valuing one or more brands comprising a method for generating a keyword and/or a method for categorising a brand.

In another aspect of the invention, there is provided a method for analysing a brand protection strategy comprising a method for generating a keyword and/or a method for categorising a brand.

In another aspect of the invention, there is provided a method for identifying a desirable brand protection strategy comprising a method for generating a keyword and/or a method for categorising a brand.

In another aspect of the invention, there is provided a method for identifying brand misuse comprising a method for generating a keyword and/or a method for categorising a brand.

In another aspect of the invention, there is provided a method for identifying and optionally analysing a competitor entity comprising a method for generating a keyword and/or a method for categorising a brand.

In another aspect of the invention, there is provided a method for ranking keywords based on advertiser competition within online advertising networks comprising a method for generating a keyword and/or a method for categorising a brand.

In another aspect of the invention, there is provided a marketing analysis method for a service provider comprising a method for generating a keyword and/or a method for categorising a brand.

In another aspect of the invention, there is provided a method for collecting information for the selection of a Nice classification for a trade mark application comprising the step of collecting data relevant to the trade mark applicant from a publicly available source of information.

In another aspect of the invention, there is provided a method for categorizing a brand comprising a method for generating a keyword and/or a method for categorising a brand.

In another aspect of the invention, there is provided a method for generating a keyword rich description comprising a method for generating a keyword and/or a method for categorising a brand.

In another aspect of the invention, there is provided a method for profiling an entity or person comprising a method for generating a keyword and/or a method for categorising a brand.

In another aspect of the invention, there is provided a method for analysing brand availability comprising a method for generating a keyword and/or a method for categorising a brand.

In another aspect of the invention, there is provided a virtual assistant method comprising interactive remote monitoring and optionally comprising assistance with use of a website.

In another aspect of the invention, there is provided a method for attracting an online trade mark application comprising providing a trade mark application interface in parallel with a domain name application or registration interface.

In another aspect of the invention, there is provided a system for generating a keyword about a brand comprising: an interface to allow a user to submit basic data; hardware and software to receive and optionally store basic data; and processing hardware to generate a keyword from the basic data.

Instructions stored on a computer readable medium, the instructions for a process for generating a keyword about a brand comprising: instructions in relation to receiving at least one element of basic data; and instructions in relation to using the basic data to generate a keyword.

In some embodiments, one or more keywords are used to categorize the brand. For example, the keywords may be compared to a database which associates each keyword with one or more categories.

Other aspects of the invention comprise systems, processes and computer readable instructions in relation to processes for example for:
Filling a form or creating a document (which may be represented in any suitable form, such as a database).
Preparing one or more applications for protection or a brand, such as for example domain name, trade mark, copyright or other applications.
brand protection Gap Analysis (such as for example domain name, trade mark, copyright, common law or other gap analysis).
Brand portfolio valuation (such as for example domain name, trade mark, copyright, common law or other portfolio valuation).
Brand protection strategy, such as such as for example domain name, trade mark, copyright, common law or other protection strategy, including for example trade mark class desirability;
Valuation of an individual brand, such as for example domain name, trade mark, copyright, common law or other valuation;
Identification of gaps in current brand protection portfolios based on one or more variables, including competitor's activities, industry, one or more financial or business indicators such stock price, corporate size, geographical reach, marketing efforts, marketing budget, employee numbers, and so on;
Identifying the most desirable brand protection strategy based on one or more variables, such as industry, geography, location of head office, location of major markets. For example, identifying the most desirable classes in which to have a trade mark registration based on one or more of these variables.
Identifying online brand misuse, such as domain name misuse, trade mark or copyright infringement, etc.
Generating a keyword rich description of a business and or a brand.
Analysing accuracy of brand protection strategy, such as trade mark filings from one or more sources of information, for example website keywords.
Valuing brand protection based on ideal competitor protection, such as for example domain name, trade mark, copyright, common law or other registrations.
Competitor identification and analysis, Category intensity, Business and/or brand identification and categorisation.
Ranking keywords based on advertiser competition within online advertising networks.
Marketing analysis for service providers, such as brand protection service providers, for example domain name sellers, or other services firms.
Virtual assistant system and method, and interactive remote monitoring and assistance with preparation of trade mark applications.

In some preferred embodiments the system, process and/or instructions of the invention are used in relation to trade marks, business names, incorporation of companies, or other applications or registrations. Individuals and entitles of various descriptions are required from time to time to make, prosecute and finalise a variety of applications and registrations. The term ‘prosecute’ is used herein to mean ‘liaise with the registration-granting body in order to see the application through to approval and subsequent registration’. The term ‘registration’ as used herein is used broadly and in general means ‘any official acknowledgement made by a granting body which requires an application, may include prosecution (liaising with the authority to have it accepted or granted) and includes the obtaining of an official confirmation from the granting body’.

Such registrations may for example be granted by or under the auspices of a government authority and may include, for example: incorporation of a company, registration of a business name, registration of an intellectual property right, obtaining regulatory approval (such as a for a food or drug product), obtaining a permit (such as for planning or building, or use of public resources, such as gaming or fishing or an environmental permit, such as carbon credits, or to undertake certain activities with an environmental impact), obtaining a government benefit (such as a tax benefit, a healthcare benefit, an employment benefit etc), and so on. Equally, such registrations may for example be granted by a non-government organisation, such as a Standards Setting Organisation, an Industry Organisation (for example for membership or some other benefit-conferring status), a loyalty program, a social networking site and so on.

In one aspect of the invention, there is provided an application method comprising the step of adding data to an interactive form wherein the data is at least partially automatically obtained from one or more data sources associated with the applicant. The application may be any suitable application.

In some preferred embodiments, the data sources comprise one or more of the applicant's computer, data associated with the applicant's IP address, data associated with a domain name registration or domain name application, data from a website associated with the applicant, data from marketing or advertising associated with the applicant, available ‘digital fingerprint’ information, or any other publicly available applicant-specific data.

Once the data is obtained, it may be utilised in any suitable way. For example, it may be at least partially automatically filled in the form for the user, or it may be displayed for the user and may for example comprise various elements of data which may be selectable by the user for inclusion in the form. In one embodiment, the data is displaced with buttons which, when clicked cause the data to be entered into the form at the appropriate position.

In another, there is provided a trade mark application method comprising the steps of: collecting relevant goods and services keywords; collecting relevant Nice Classification classes; and creating the application specification.

Another aspect provides a method of attracting an online trade mark application comprising providing a trade mark application interface in parallel with a domain name application or registration interface.

One aspect is a method of collecting keywords potentially relevant to an application (of any suitable type) comprising the step of collecting data relevant to the applicant from a publicly available source of information. In some preferred embodiments, the application is a trade mark application and in some embodiments, the source of the data comprises one or more of: the applicant's computer, data associated with the applicant's IP address, data associated with a domain name registration or domain name application, data from a website associated with the applicant, data from marketing or advertising associated with the applicant, available ‘digital fingerprint’ information, or any other publicly available applicant-specific data.

A further aspect is a method of collecting information for the selection of a Nice classification for a trade mark application comprising the step of collecting data relevant to the trade mark applicant from a publicly available source of information. In some preferred embodiments, the source of the data comprises one or more of: the applicant's computer, data associated with the applicant's IP address, data associated with a domain name registration or domain name application, data from a website associated with the applicant, data from marketing or advertising associated with the applicant, available ‘digital fingerprint’ information, or any other publicly available applicant-specific data.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### DETAILED DESCRIPTION OF CERTAIN EMBODIMENTS

It is convenient to describe these aspects of the invention herein in relation to particularly preferred embodiments. However, the invention is applicable to a wide range of applications and it is to be appreciated that other constructions and arrangements are also considered as falling within the scope of the invention. Various modifications, alterations, variations and or additions to the construction and arrangements described herein are also considered as falling within the ambit and scope of the present invention.

### Implementation of Some Embodiments of the System

The current invention may be implemented in a variety of ways. One preferred method is to make the process available through a website interface. Other implementations may for example include ones in which part of the process is performed and sent (for example by email) to a potential customer (for example as a partially completed form), or an email with a specially coded hyperlink which, when clicked, leads the potential customer to a website which already contains the results at those steps of the process already completed and enables the customer to continue and complete the process. In other embodiments, another form of communication is used, which may include a chat area on a website, a popup window, etc. Any suitable communications network may be used, for example a network of computers, such as the internet, an intranet within an organisation, a network comprising one or more handheld devices and so on.

Wherever in this description a number of options are presented with different characteristics (such as a different relevance ranking), those different characteristics may be represented in any suitable way, for example, by text (for example, by the words “good”, “better” and “best), by images (for example, by the number of stars) or by formatting (for example, a “tag cloud” where more relevant terms appear in larger font) and so on.

### Categorizing a Brand

In one aspect of the current invention it uses basic information regarding the brand, such information may for example include domain name registration information, results from internet searches, trade mark information, and so on, to obtain a number of keywords using various methods and from various data sources and then, by mapping those keywords against certain data, prepares a draft categorization and in some embodiments, optionally a draft filled form for review and completion by the user. It should be noted that in some embodiments, any given brand may be appropriately assigned to more than one category. Thus a brand relating to tennis shoes may be relevant both to any one or more of (a) foot ware, (b) sports apparel, (c) goods containing rubber—and so on. Categories can be refined to include or exclude certain types of results.

### Basic Form or Document Details

Basic details may be obtained in any suitable way. For example a system or process according to the present invention may:
ask the applicant for some basic information, such as an existing domain name, brand name, or other registration details and obtain added detailed information from an online information source, such as the domain name registration information from the WHOIS database (or similar registration database) or as described elsewhere herein; and/or
if the applicant is in the process of undergoing another process, such as registering a domain name, take the information as entered in previous steps of filling the form (for example the domain name application); and/or
take the information from one or more locations identified from the data already entered by the applicant. Thus, in some embodiments where the applicant has provided a company name, the name may be used to search for equivalent domain names and relevant websites may be searched for relevant information.

A mapping between the basic information search results (for example name and name and address for correspondence) can be applied as a suggestion to the applicant for the corresponding fields to be completed in a form. The applicant may then accept or modify the suggestion before electing to continue.

Step 1a—Collection of Keywords

This first step results in the creation of a Keyword List, for use in Step 2,

A. Domain Name

Typically domain names are selected because they either match exactly or are closely related to the registrant's brand or product names, or describe the nature of the goods and services for which they are used. In many cases, the more descriptive the domain name of goods, or services, the more valuable that domain name is.

Registration strategies for domain names often include registration of English words, sometimes joined together without spaces (relying on capitalisation to separate the words), separated with a hyphen or pre-fixed or post-fixed with common words such as “my”, “now” or “online”.

The current invention may generate keywords in part by examining the domain name, separating any known English words and discarding common pre-fix and suffix words or part words. The resulting words are highly likely to be descriptive of the goods and services intended to be used in connection with the domain name. Those words may be added to the Keyword List.

B. Domain Name Registrant Entity

Each domain name is required to be registered by a legal entity. In many cases that entity may be a corporation rather than an individual. The entity name can be used in a variety of ways to determine relevant keywords. For example, in some cases the entity name will be descriptive of the goods and services relevant to the entity. In the same manner as the domain name, the entity name can be split on English words and the resulting words are likely to be descriptive of the goods and services intended to be used in connection with the domain name. Those words may be added to the Keywords List.

The entity name can also be used to locate existing data for the same entity (for example in a database of completed registrations of the type for which the current form is being filled). It is highly likely that the same entity would require similar details to be used in a subsequent entry. Keywords from those previous instances may be added to the Keywords List (or alternatively, aspects of the prior instances can be noted as being relevant regardless of the Keyword List).

The entity name can be used as a search term more generally as below.

C. Contents of Website at Domain Name URL

It is likely that there will be content at relevant websites which is relevant to the details required on a form to be filled or document to be created (some content will be more relevant than other content—such as page titles, headings, tag clouds and text within links as described in section 1b below). It is also likely that the applicant has included “keywords” or “meta-tags” (or similar) within the website for the purpose of guiding search engines as to what search terms are relevant to a brand. The full text of the website, the keywords and meta-tags and any other similar information can be used as relevant keywords and those words may be added to a Keyword List.

It is anticipated that, for some websites, there may be too many keywords generated by using the full text of the website. The content may be too “noisy” to add meaningful keywords to the Keyword List. In such cases it is anticipated that a “reverse search” can be used to determine whether any of the terms used in the database (see for example the trade mark goods and services classifications in the example described below) appear within the text of the website. If any of those words appear in the webpage, those words are added to the Keywords List.

Further, it is anticipated that the scope of keywords can be narrowed by identifying certain of the details already entered in the form or document (such as the basic information) on the website and, rather than all of the keywords being added to the Keyword List, only those which are a predetermined proximity to the nominated information be added to the Keywords List.

D. Usage of the Domain Name or Brand Name in Commercial Advertising Feeds, Such as Google Ad Words

Pay-per-click advertising often relies on keywords to present relevant advertising to subscribers and end-users. Therefore it is possible to provide the brand name and/or domain name to a provider of advertising feeds and obtain the relevant keywords under which those terms appear. Those search engine keywords can then be added to the Keywords List.

E. Contact Email Extensions from Registration Information

For each domain name registration there are a number of contacts (normally a registrant contact, administrative contact and technical contact). In many cases the administrative contact and technical contact are third parties who provide services to the applicant. In some cases the registrant will have acquired a “private registration” service whereby the registrant uses a third party as a virtual “post box” for all contact details. However, in many cases the contact details for the domain name will include an email address operated by the applicant directly. One example of this is where the applicant works for an entity which has more than one domain name managed through a single email address. In that case, the email address is likely to refer to the applicants main entity or brand website.

In such cases, the email address domain name can be used in the same manner as the applicant's domain name, and can be passed through the process described above, and the resulting keywords may be added to the Keyword List.

In some cases keywords identified using this technique which relate to domain name registration, webhosting or other services typically related to domain name services may be discarded as being more likely to relate to a third party rather than the registrant themselves.

F. Computer Name, Network Name and Email Address or Person Accessing a Website

Many forms are typically filled online. There are a number of “digital fingerprint” information sources provided by the end user of the website, such as their computer name, the owner of the Internet protocol addresses from which the user's computer is being operated and any login or other such credentials (including stored information from previous user sessions) that the user may provide. Information from those sources can be used in the same manner as the registration information above and the keywords generated may be added to the Keywords List.

As above, where for example keywords generated from the ownership of Internet protocol addresses relates to the provision of Internet telecommunication services they are more likely to refer to a third party than the user of that particular Internet protocol address and therefore may optionally be discarded.

G. Directory Service Categorisation and Keywords

External third party directory service databases may be searched to determine categories of business undertaken by the applicant using either the applicant's name and/or domain name. Examples of such directory services include business name registrations which record some indication of the business undertaken by the registrant, business telephone directories such as the Yellow Pages, and online directories such as those compiled by Yahoo directory and the Open Directory Project (located at http://www.dmpz.org). The categorisation of the applicant in such third party directories is likely to be consistent with the business undertaken by the applicant and therefore relevant to the goods and services described in trade mark applications made by the applicant. Categorisation keywords can be added to the Keyword List.

H. Digital Certificate Details

In many cases online transaction security may be provided by using a digital certificate which is compatible with one or more common web browsers. Such digital certificates can be automatically downloaded from an applicant's website and store the relevant entity name. When used in connection with a domain name, digital certificates often store the registrant entity name and optionally other information relating to the registrant, which may then be used in the methods described above to create Keywords and add them to the Keywords List.

I. Other Domain Names Hosted on the Same Web Server(s)

It is common for registrants to host multiple domain names on the same set of web servers or delegate multiple domain names to the same set of nameservers (which servers are responsible for resolution of the domain name to an Internet protocol address). Domain names on the same server or nameservers can be identified using the DNS or the WhoIs database. In some cases, a series of domain names will be used by a registrant in relation to the same business. Where that is the case, each domain name can be used as described above to add keywords to the Keywords List.

As noted above, where the keywords generated relate to webhosting services, they may optionally be discarded as being more likely to refer to a third party.

J. Other Domain Names Registered by the Same Registrant

The WhoIs database may be analysed to determine other domain names which have been registered by the same registrant. In some cases, a series of domain names will be used by a registrant in relation to the same business. Where that is the case, each domain liable can be used as described above to add keywords to the Keywords List.

K. Forwarded Domain Names

Multiple domain names are often registered and forwarded to the same website, both to assist in search engine rankings, and to provide multiple gateways to the same site. For example, a registrant operating a travel business called “Melbourne Travel” might register “mt.com”, “melbournetravel.com” and “melbourne-travel.com” and forward all users access those websites via those domain names to the same Internet website. Such forwarded domain names can be identified using user account details and by querying the DNS and WhoIs. Each such forwarded domain name can be used as described above to add keywords to the Keywords List.

L. Inbound and Outbound Links

Websites often contain hyperlinks to other content which is relevant to that particular website. In the case of business websites, such links are likely to be to further information in relation to the goods and services provided by the business (“outbound links”). Further, other websites may link to a brand or an entity's websites in order to provide further information or to link to relevant goods and services (“inbound links”). Inbound links to, or outbound links from websites may be analysed to identity additional keywords. Different weightings may apply to text within the link, the URL (or elements of the URL to which it links) and text around the link on the website page. Each domain name and page which is linked to and linked from may be analysed for keywords using the techniques described in this section.

M. Registered Domain Name Partial Matches

As described above, brands, domain names and entity names can often be split into multiple English words. These words can be used to perform a substring search on a database of registered domain names to find additional domains which contain one or more of the words. As described above, domain names are often registered due to their descriptive nature and therefore it is likely that domain names with similar English words will be used in relation to websites relevant to similar goods and services. Where such domain Names are identified, each such domain name can be used as described above to add keywords to the Keywords List.

N. Search Engine Matches

The brand, keywords and domain names identified in this section may be submitted to search engines to find the highest ranked search results for those terms. These sites will often be offering the same goods and services as the applicant, and thus each site found may be analysed for keywords using the techniques described in this section.

O. Similar Sites Service

Search engines and web information services such as Alexa offer services which return similar sites (related links) when supplied with a domain name or brand. These sites will often be offering the same goods and services as the applicant, and thus each site found may be analysed for keywords using the techniques described in this section.

P. Patent Registrations

In some cases the applicant for a trade mark will also have published patents or patent applications. Such patents are likely to be in relation to the same or similar goods and services as the goods and services for which a trade mark is being applied. New keywords can be extracted from the patent description, specification and the international classification of the patent.

Q. User Generated Keywords

The end user may be invited, my means of a free form, text input area (such as a textbox on an Internet web page) to input information about the goods and services which are relevant to the trade mark being applied for. This can either be keywords or natural language describing the goods and services. That information may be added to the Keyword List.

R. Social Networking and Aggregator Websites

Many entities participate and use their brands in at least one online social networking website (such as FaceBook, Myspace, LinkedIn, Twitter, and the like). These sites can be searched for relevant content, links and other information to add to the Keyword List. Similarly, entities may be members of industry organisations or other groups based on interests. These sites can be identified from analysis of the collected information and searched for further Keywords.

This is a non-exhaustive list and provided only by way of example. There are other ways in which to collect keywords.

Step 1b—Expansion of Collected Keywords

The list of collected keywords may be expanded upon in various ways. For example:

A. Synonyms, Inflections and Plurals/Singulars

Each keyword can be expanded upon without losing or diluting the intended meaning by collecting synonyms, inflections and plurals/singulars for each keyword and adding those new words to the Keyword List.

B. Spelling Corrections and Common Typing Corrections

Dictionary lookup may occur to determine correct spelling or closest suggestions for each keyword to generate additional keywords. Common typing errors may be substituted to generate additional key words. Different spelling for words can also be used to substitute the words into the same language (for example, moving from US spelling to UK spelling).

C. Acronym and Abbreviations

An acronym and abbreviations dictionary may be used to expand supplied keywords. For example, the keyword ‘ip’ may be expanded to both ‘Internet protocol’ and ‘intellectual property’.

D. Hyphens and Other Punctuation

Punctuation can often be inconsistently used, for example whether a word has a hyphen or is two separate words. Both can be optionally used or a suitable standardisation can be applied.

Step 1c—Ranking of Collected Keywords

As a result of the above steps a Keyword List will be generated. However, because the keywords in the Keyword List are generated using different techniques, the relevance of each keyword may be different. It is therefore desirable to employ a method to minimise the chance of a less relevant keyword from a less reliable source overriding more relevant keywords from more reliable sources without discarding entirely any keywords.

A preferred method for achieving that objective is to assign a ranking to each keyword, which may be any arbitrary thing provided that keywords can be compared with each other (a preferred embodiment having keywords ranked using numbers 0 to 100 indicating the relevance of the particular keyword, 0 a being least relevant and 100 being most relevant),

Rankings may be assigned by each at the methods described above. In addition, each method may have a relevance modifier assigned based on the relevance assigned to results generated by each method. The final relevance of a keyword may therefore be calculated by applying the relevance modifier for the relevant method to the relevance of the keyword assigned by the method. As an example, keywords directly entered by the applicant on an interactive form would be given the highest rating, and the method used would also be given a high weighting leading to a high overall score.

Each of the methods used to collect and rank keywords may perform a number of operations including:

A. Removal of Irrelevant Words

Certain words will be deemed to be so generic and therefore should not be included in the Keywords List. If, once the Keyword List has been collected any such words are included, those words will be removed. Examples of such words are “a”, “and”, “the”, “if”, “in”, “including” and “namely”.

B. Keyword Density

When processing content such as the keywords that appear in the text of a website, keywords may be ranked by the number at times they occur on the page or website. For example, if the keyword “engineering” appeared ten times, and the keyword “copyright” appeared once, then “engineering” would be given a higher relevance than “copyright”.

C. Structural Content

When processing content such as the keywords that appear in the text of a website, keywords may be ranked by analysing the structure of the text or mark-up. For example, keywords that appear in the meta-tags, page title, tag clouds or that appear in headings or with larger size fonts would be ranked higher than general text that appears on the page. As an example of a relevance ranking scheme that may be applied:

a. Keywords that appear in page footers (such as copyright messages) may be assigned a low rank;

b. Keywords that appear within content regions generated by third parties (such as advertisement provided by Google), may be given a lower ranking than content generated by the website applicant, but higher than page footers.

c. Keywords that appear within content regions generated by site users (such as blog comments) may be given a lower ranking than all ether content on the website.

D. Keyword Proximity

When processing content such as the keywords that appear in the text of a website, keywords may be ranked by analysing the proximity of each keyword to keywords which have already achieved a high ranking, such as keywords directly supplied by the applicant. For example, if the user supplied the keyword “credit” and the keywords “card” and “finance” were found in close proximity, the keywords “card” and “finance” would be given a higher ranking than other keywords on the page.

E. Word Type

Keywords may have a relevance modifier based on word type, including adjective, noun, pronoun, verb and adverb. For example, a noun may have a higher relevance modifier than a verb.

F. Exact Match and Partial Match

When website content, or databases are being searched (such as a database of all registered domain names), different relevance may be given to keywords which are an exact match (higher relevance) or a partial match (lower relevance) to the search term. In addition, partial matches that either start with or end with a keyword may be given higher ranking than a middle-of-the-word match.

G. Domain Name Extension

Domain names are organised into different domain name spaces denoted by the domain name extension. Domain names are often registered in a particular domain name space depending on the activities intended to be undertaken by the registrant. This provides an additional descriptive element to a domain name which it may not have without the domain extension. Some domain name extensions are described as “open” in that they do not have, or have very few, rules in relation to the registration at domain names under them. Other domain spaces are described as “closed” in that they have registration requirements which are relevant to the activities undertaken by the registrant. In most cases, those categorisations are not, of themselves, sufficient. However, mapping the extension against common categories provides additional guidance on what categorisation may be relevant.

An example mapping appears below.

| Domain | |
|---|---|
| space | Likely relevant trade mark class |
| .net | Class 38-Telecommunications |
| .edu | Class 41-Education; providing of training; |
| | entertainment; sporting and cultural activities |
| .tv | Class 38-Telecommunications |
| | Class 41-Education; providing of training; |
| | entertainment; sporting and cultural activities. |
| .int | Class 45-Legal services; security services |
| | for the protection of property and individuals; |
| | personal and social services rendered by |
| | others to meet the needs of individuals. |

Other mappings are also possible. Further, as new, more descriptive domain spaces are released, more mappings will be possible. Each of the keywords for those classes may be added to the Keyword List (or alternatively, the class can be noted as being relevant regardless of the Keyword List).

H. Relevance Weighting of Categories Based on Keyword Frequency in the Categorisation Database

By recording the number of occurrences in each class of each word used to categorise brands, it is possible to determine which class is more likely to be relevant for a particular keyword. For example, “tree” may occur many times in certain categorisations, but much fewer times in any of the other classes. Therefore the keyword “tree” in a description of goods and services for a new application is more likely intended to be in one categorisation than another.

In order to implement this process, a hash table of each keyword used in an entity's description of itself and/or its brands and the categorisation to which it is relevant is created. Each self description is examined one word at a time. For each word, a search is undertaken of the entire categorisation database and the number of occurrences of that word in each category is compiled. The search for each word is only undertaken once. Common words such as “a”, “and”, “the”, “including” and “namely” can be ignored. In one embodiment the database is represented by a row for each word identified and a column for each category. Once the hash table is complete, it is then possible for each keyword to determine the most likely category for that particular keyword. Weightings can be applied based on the type of categorisation.

As different products evolve and terms come in and out of use, the above process can be used to update the relevance of particular categories to each keyword. The process can be executed as frequently as new data is available and separate from the processing of forms, categorisation requests and applications.

Keywords can be generated by serial or parallel processes, with a significant processing efficiency in undertaking each of the above in parallel. Further, significant processing efficiencies result from caching of results from previous searches for a particular end user, both across a single session and across different sessions. In one embodiment, keywords can be stored together with the end user's details in a user account.

In a preferred embodiment methods which can be performed in advance will be done in bulk and databases containing the results for later use will be constructed. For example, registered domain names, WhoIs information, digital certificates and web site content may be downloaded and processed in advance.

In a preferred embodiment, the keyword collection and keyword ranking methods may implement a quality threshold cut-off, meaning that once either a pre-determine number of highly relevant keywords have been collected and/or a pre-defined amount of time has passed, no further keywords will be collected for processing. Such a quality threshold cut-off will further accelerate the performance of the system.

Step 2a—Collection of Relevant Categories

A second step is to use the Keyword List generated in Step 1 to derive the recommended terms in each relevant category.

In processing the Keyword List, and prior to adding the relevant term and category to the draft specification, optionally each Keyword, term and category can be used as a search term against the relevant terms and categories of all previously categorised brands. If such search returns a positive match and the relevant trade mark matches the desired trade mark (whether exactly, sounds like or visually), such Keyword, term and/or class can be signalled to the end user (using words or images) as either being “unavailable for registration” or being “unlikely to be accepted for registration”. The keyword can have associated with it a hyperlink which when clicked on provides further information in relation to the registered trade mark or trade mark application which has caused the keyword to be indicated as such. Such availability search can be conducted interactively by the end user as keywords are added in step 1.

The process of matching Keywords, terms and classes in the draft specification to existing registered or pending trade marks can be undertaken in a number of ways, including (either separately or together):
1. “matching availability search”—using a text search of each Keyword, term and class (individually or in different combinations) each match identifies that particular Keyword, term and/or class as being “unavailable for registration” or being “unlikely to be accepted for registration”;
2. “normalisation availability search”—in this alternative; the specification from each registered or pending trade mark is used as a Keyword List for the above process with the result of both the existing registered or pending trade mark and the current application being described in a common set of terms derived from the same terms and classes database. Terms which are not able to be converted into the particular terms and classes database may remain as “free form text”. Once the normalisation is complete, using a text search of each Keyword, term and class (individually or in different combinations) each match identifies that particular keyword, term and/or class as being “unavailable for registration” or being “unlikely to be accepted for registration”. Efficiencies in this process can be obtained from normalising the trade mark specifications in parallel, pre-processing the normalisation of the trade marks database or by only focusing on the particular classes in which the applicant is applying.

In one embodiment applicants may be invited to add brand names and domain names to the keywords. Such names could be of those persons whom the applicant knows is competitive with the applicant or offers the same or similar goods and services as the applicant. From that information, any brand protection strategies, for example, trade mark applications or registrations for that person (or in the case of a domain name, the registrant of the domain name) can be identified. It is efficient and improves the quality of applications if the applicant can use the same or similar phrases which have already been filed by other applicants in relation to particular classes for the same or similar goods and services.

One implementation would be that for each search term the end user types in, in addition to other suggestions of relevant categories and phrases to add, a look up can be performed of the existing categorisation database. If the search term matches an existing categorized brand name, the user can be asked whether they would like to see details of the categorisation. If the user chooses to view them, all phrases used to categorise brands of that particular entity, regardless of the mark to which they are registered, are displayed to the user, organised by category. Each phrase is divided by the “;” character. The user can then elect to add one or more of those phrases to its own description in the same category in which the other entity has used it.

Step 2b—Ranking of Classification Categories

Each keyword from the Keyword List can be used as a search term on the database. For each match, the relevant term and the category in which that term appears is added to the draft categorisation, or as one embodiment in an interactive interface, may be presented to the applicant as a list of brand categories which may be selectively added to the draft Specification.

The same operations described above to assign relevance ranking to keywords can be used to provide a relevance ranking to specification terms and categories based on the keywords that appear within those specification terms. Processing steps may include: keyword density; synonyms; acronym expansion; exact and partial keyword matching; word type; plural and singular; structural content; keyword proximity; removal of irrelevant keywords.

To assist the applicant to finalise the specification (including for the purposes of allowing the applicant to understand and control costs), the categorisation may be displayed in order of ranked relevance rather than numerical or alphabetical order. Different anticipated embodiments include the display order being determined in part or whole by one or more or the following factors:
the sum of the rankings of keyword matches within that particular category—the greater the sum of the rankings the higher the relevance.
the number of overall applications in each particular category during a prior period—the greater number of registrations the greater the relevance.
previous categories in which the applicant has registered trade marks
the categories most likely to be reviewed by potential customers of the brand owning entity

### Step 3—Creation of a Filled Form or Document

At the end of the above process a complete form or document with relevant categorisations will be presented to the applicant to review and finalise. Finalisation by the applicant may involve reducing the number of categories requested, removing or adding new keywords to the Keywords List and restarting Step 2 and/or removing/revising the description within the categories remaining.

In preferred embodiment Step 2 is performed in parallel with Step 3, giving the end user an interactive interface (which may be provided via a website) for the preparation of the categorisation and filled together with real-time or near real-time feedback on availability keyword and specification term selections.

Once the applicant is satisfied with the form or document, the person acknowledges it and instructions are sent to be processed for lodgement. In some embodiments, processing is automated and via a communications network. In other embodiments, processing may be undertaken by a local representative, lawyer or other authorised person or may be an administrative representative of the applicant who undertakes the lodgement process on the applicant's behalf.

### Payment

Where required, payment may be effected at any suitable time. In certain preferred embodiments, credit card details are required in order to request that a certain form be filled and filed. Thus, for example, the credit card details may be provided on the first or second screen viewed by a user and payment effected once the specification is approved in Step 3.

### Basic Details

Basic details may be obtained in any suitable way. For example a system or process according to the present invention may:
ask the applicant for some basic information, such as an existing domain name, brand name, registration details and obtain added detailed information from an online information source, such as the domain name registration information from the WHOIS database (or similar registration database); or
if the applicant is in the process of undergoing another process, such as registering a domain name, take the information as entered in previous steps of filling the form or creating the document (for example the domain name application).

A mapping between the basic information search results (for example name and name and address for correspondence) can be applied as a suggestion to the applicant for the corresponding fields to be completed in the form or document. The applicant can then accept or modify the suggestion before electing to continue.

### System Characteristics

A system according to the present invention may comprise any suitable components. In it's simplest form, the system may comprise a server or computer comprising computer readable code with instructions for performing one or more steps of the methods described herein. The method of the present invention can technically run on a server or computer with surprisingly low computing power such as 100 MB spare memory and a slow CPU, such as a 1 GHz processor. However, such a system would suffer performance issues with large numbers of users seeking to send instructions to have the server or computer perform the method of the invention. Such performance issues are not as significant where the system is operated by a single user on their own computer.

In some embodiments, the system requirements are such that 0.25-seconds of a CPU-core time is used per set of instructions (or search). Note that modem server CPUs have 4-6 cores per CPU and 2-4 CPUs per server). Thus for example, a system comprising a standard modem server with 8-cores (2×4 core CPUs), could handle 32 searches per second. In this example, if one assumes that a user on average performs 9 search per 60 seconds interval, we would support 32 (searches per second)×60 seconds=1920 concurrent users per server. Where multiple cores are present, different threads of parallel processing described above can be optimally spread across different cores. Alternatively, different cores can be used to service different individual users, or a combination of the two.

### EXAMPLE 1

### Preparation of Trade Mark Duplications

A trade mark is a mark (whether it is a word, phrase, letter, number, sound, smell, shape, logo, picture, aspect of packaging or a combination of these etc) which is used to distinguish the goods and services of one trader from those of another. Registration of a trade mark gives the registrant a legal monopoly right to exclude others from using the trade mark within the jurisdiction and for the goods and services for which it is registered. Trade marks are recognised in a number of countries pursuant to international conventions and implementing legislation in each relevant country. There are approximately 4 million trade marks registered in the United States. Application fees for registering a trade mark range from approximately $300 to $3,000, usually depending on the time taken to draft the specification. Trade mark applications are almost always prepared by someone familiar with the trade mark process, such as a trade marks attorney or lawyer.

One area of complexity in trade mark applications arises from the requirement that the trade mark be registered for particular goods and services. That description of goods and services, while it must be characterised in relation to at least one of 45 different classes, may be drafted individually for each relevant trade mark. Significant skill is employed in preparing trade mark specifications which are wide enough to protect the applicant's rights, but not so wide that the application will be rejected by the examiners or subject to legal objection at a later time.

For this reason (amongst others) the trade mark application process often involves a registered practitioner on behalf of the applicant (his or her client):
Meeting with the client to take instructions to file a trade mark;
Considering the scope of the business undertaken by the client;
Taking instruction on the goods and/or services in relation to which the mark is to be used;
Considering the current registrations for similar marks and similar goods and services;
Optionally conducting a wider search for use of the mark by others in commerce but without trade mark registration;
Drafting a trade mark application specification;
Sending the specification to the client for its comments;
Incorporating any comments from the client into the specification (and repeating where necessary); and then
Lodging the application with the relevant trade mark office.

The steps undertaken above, being undertaken by a registered practitioner, account in part for a relatively higher fee to lodge the trade mark application (as compared to other “brand related” registrations which are recorded on a central registry, such as business names and domain names).

Applicants who are not skilled in the art themselves and who do not use a third party who is skilled in the art, typically find it difficult to prepare an effective specification.

A further issue that arises relates to the applicant being able to determine the availability of a particular desirable mark prior to the application being lodged. Typical “word search” of registered marks which may be used to search other registries (such as business names and domain names) does not correctly identify the availability of desired marks nor potentially conflicting marks. For example, a particular mark registered in class 9 may still be available for registration in class 10 by a different applicant. Typically applicants will engage the services of a trade marks attorney or lawyer (or someone skilled in the art) to conduct availability searches on their behalf and report the likelihood of a desired mark being available for registration. This additional step adds to the perceived difficulty in lodging a trade mark applications and the cost of obtaining a trade mark registration.

Contrast with Domain Name Applications

Domain name licence agreements (often referred to as “registrations”) are a services agreement between a registrant and the registry (normally through a registrar) to enter the registered domain name into the authoritative domain space registry. That authoritative registry can then be used by third parties to resolve an Internet protocol address from the registered domain name. During the period of registration the registrant has a monopoly right over the use of that domain name for the purposes of effecting the resolution. There are over 100 million domain names registered in the top level namespaces. Domain name applications are seen by the market as a commodity services, with prices for registration ranging from $0 to approximately $100. Domain name applications are often prepared and lodged by a person without any familiarity with the domain name process, and rarely by lawyers. There is formal accreditation process to become the equivalent of a trade marks attorney in relation to domain name registrations.

In contrast to the current method of preparing trade mark applications, a domain name application is an automated process in which the applicant completes an application form (typically online and requiring details of the domain name to be registered, the various contact details for and on behalf of the registrant and payment information) which is then lodged directly to the registry. The process does not normally involve manual intervention by the service provider, nor any specialist advice, which accounts in part for the lower fees compared to a trade mark registration.

It is often the case that a person anticipating the commencement of a new commercial undertaking will “reserve” the name of the business or product by registering it as a domain name in the “.com” space prior to registering a business name, incorporating a entity or registering a trade mark. In contrast, it is often the case that trade marks are not registered until some time after the commercial enterprise has commenced and provided some indication that it may be successful.

There are a number of reasons for this behaviour including that, in comparison to a domain name registration, a trade mark application is expensive (due to the experience and skill used to prepare the specification) and, when compared to domain names, trade mark applications involve a longer, more time consuming process than considered warranted to protect something that has yet to fully mature into a commercial enterprise. Domain name applications are typically seen as a “spur of the moment” action, whereas trade mark applications are not.

Finally, due to the apparently complex choice of classes and categorisation of goods and services, trade mark applications are not often undertaken by people unskilled or inexperienced in preparing such applications. Domain names on the other hand do not, of themselves, record the goods and services for which the domain name is to be used (for example, a registration in the “.com” space may be used for any number of goods or services) and therefore the process is perceived as being less difficult and can be undertaken by someone without any prior knowledge or particular skill.

Domain name applications also benefit from the ability for an applicant to conduct a real time availability search for their desired domain name. Availability searches can be conducted using a simple word search on the “whois” domain name database. Registrars are often required to provide this functionality to the public via their website. In this way, the unskilled applicant can determine quickly whether the desired domain name is available for registration.

### Issues to be Addressed

With the above issues in mind, it is not therefore obvious how a person (being an individual or a entity) who:
may already have a domain name; or
may be in the process of registering a domain name; or
has information regarding that person recorded in a database,
   can:
determine the availability of a particular trade mark; or
prepare trade mark application instructions; or
identify new or additional trade marks which would be desirable for its business;
   in a cost effective manner without:
intervention by a third person who is skilled in the art (such as a lawyer or trade mark attorney); or
the person themselves having skill in preparing trade mark applications,
   and, where the person is registering a domain name, with such application instructions being finalised together with or close in time to instructions to register or renew a domain name.

### Implementation of the System

This aspect of the current invention may be implemented in a number of different ways. Given that domain names are often purchased using a website, the preferred method is to make the process available through a website interface. Other implementations whereby part of the process is performed and emailed to a potential customer (in the form or a report or an invitation to take-up a registration), which email includes a specially coded hyperlink when clicked, leads the potential customer to a website which already contains the results of those steps of the process already completed and enables the customer to continue and complete the process.

Wherever in this description a number of options are presented with different characteristics (such as a different relevance ranking), those different characteristics may be represented by text (for example, by the words “good”, “better” and “best”), by images (for example, by the number of stars) or by formatting (for example, but a “tag cloud” where more relevant terms appear in larger font).

### Creation or the Trade Mark Applicant Details

In many cases, businesses have considered which entity in the corporate structure will be responsible for holding intellectual property. For these purposes, domain names are often treated in the same manner as intellectual property.

Domain names are required to be registered to a legal entity. Registration information, to take the .com space as an example, includes the name of the registrant and a name and address used for correspondence in relation to the domain name. Most other domain spaces require similar information.

In some embodiments, the current invention may either:
ask the applicant for its existing domain name and obtain the domain name registration information from the WHOIS database (or similar registration database); or
if the applicant is in the process of registering a domain name, will take the domain name application information as entered in previous steps in the domain name registration process.

A “one to one” mapping between the domain name registrant name and name and address for correspondence can be applied as a suggestion to the applicant for the corresponding trade mark application fields. The applicant can then accept or modify the suggestion before electing to continue.

### Creation of the Trade Mark Application Specification

Trade marks must be registered in relation to particular goods and services. Domain names do not have that same requirement and therefore there is no “one to one” mapping between the express domain name registration information and a trade mark registration for the goods or services which are offered at or in connection with that domain name.

The current invention uses information regarding the applicant, including domain name registration information, to obtain a number of keywords using various methods and from various datasources and then, by mapping those keywords against existing descriptions of goods and services, prepares a draft specification.

Step 1a—Collection of Relevant Goods and Services Keywords

This first step results in the creation of a Keyword List, for use in Step 2.

A. Domain Name

Typically domain names are selected because they either match exactly or are closely related to the registrant's brand or product names, or are descriptive nature of the goods and services for which they are used. In many cases, the more descriptive the domain name of goods or services, the more valuable that domain name is.

Registration strategies for domain names often include registration of English words, sometimes joined together without spaces (relying on capitalisation to separate the words), separated with a hyphen or pre-fixed or post-fixed with common words such as “my ”, “now” or “online”.

The current invention generates goods or services keywords by examining the domain name, separating any known English words and discarding common pre-fix and post-fix words. The resulting words are highly likely to be descriptive of the goods and services intended to be used in connection with the domain name. Those words may be added to the Keyword List.

B. Domain Name Registrant Company Name

Each domain name is required to be registered by a legal entity. In many cases that entity will be a company rather than an individual. The company name can be used in two ways to determine relevant goods and services keywords. First, in some cases the company name will be descriptive of the goods and services relevant to the company. In the same manner as the domain name, the company name can be split on English words and the resulting words are likely to be descriptive or the goods and services intended to be used in connection with the domain name. Those words may be added to the Keywords List.

Second, the company name can be used to locate other existing trade mark registrations for the same company. It is highly likely that the same company will apply for a number of products which relate to similar goods and services. Therefore, previous classes in which the domain name registrant has applied for trade marks are likely to be relevant to the classes in which the applicant is currently applying. Keywords from those previous registrations may be added to the Keywords List (or alternatively, the class can be noted as being relevant regardless of the Keyword List).

C. Contents of Website at Domain Name URL

There are two methods by which the applicant might elect to register a trade mark. First, an applicant may elect to register the trade mark at the time of undertaking a new the domain name registration. In these circumstances, it is unlikely that there will be any website content established at the domain name URL, unless the applicant is purchasing a domain name that has been used previously.

However, as noted above, many people elect to register a domain name first, then once the commercial enterprise has been established, register a trade mark at a later time. Or they may already have an established business, but may be looking to register a trade mark for a new or existing product. In such cases, it is likely that there will be content at the relevant website which is relevant to the goods and services intended to be offered by the applicant in connection with the trade mark (some content will be more relevant than other content—such as page titles, headings, tag clouds and text within links as described in section 1b below). It is also likely that the applicant has included “keywords” or “meta-tags” (or similar) within the website for the purpose of guiding search engines as to what search terms are relevant to that entity and its business. The full text or the website, the keywords and meta-tags and any other similar information can be used as relevant goods and services keywords and those words may be added to the Keyword List.

It is anticipated that, for some websites, there may be too many keywords generated by using the full text of the website. The content may be too “noisy” to add meaningful keywords to the Keyword List. In such cases it is anticipated that a “reverse search” can be used to determine whether any of the terms used in the trade mark goods and services classifications (described below) appear within the text of the website. If any of those words appear in the webpage, those words are added to the Keywords List. Further, it is anticipated that the scope of keywords can be narrowed by identifying the trade mark being applied for in the website and, rather than all of the keywords being added to the Keyword List, only those which are close in proximity to the trade mark be added to the Keywords List.

D. Usage or the Domain Name or Company Name in Commercial Advertising Feeds, Such as Google AdWords

Pay-per-click advertising often relies on keywords to present relevant advertising to subscribers and end-users. Therefore it is possible to provide the company name and/or domain name to a provider of advertising feeds and obtain the relevant keywords under which those terms appear. Those search engine keywords can then be added to the Keywords List.

E. Contact Email Extensions from Registration Information

For each domain name registration there are a number of contacts (normally a registrant contact, administrative contact and technical contact). In many cases the administrative contact and technical contact are third parties who provide services to the applicant. In some cases the registrant will have acquired a “private registration” service whereby the registrant uses a third party as a virtual “post box” for all contact details. However, in many cases the contact details for the domain name will include an email address operated by the applicant directly. One example of this is where the applicant works for a company which has more than one domain name managed through a single email address. In that case, the email address is likely to refer to the applicants main company Website.

In such cases, the email address domain name can be used in the same manner as the applicant's domain name, and can be passed through the process described above, and the resulting keywords may be added to the Keyword List.

F. Computer Name, Network Name and Email Address of Person Accessing a Website

Domain name registrations are typically undertaken online. While not required, it is anticipated that the trade mark application processes could also be undertaken online, if that is the case, there are a number of “digital fingerprint” information provided by the end user of the website, such as their computer name, the owner of the Internet protocol addresses from which the user's computer is being operated and any login or other such credentials (including stored information from previous user sessions) that the user may provide. Information from those sources can be used in the same manner as the registration information above and the keywords generated may be added to the Keywords List.

G. Directory Service Categorisation and Keywords

External third party directory service databases may be searched to determine categories of business undertaken by the applicant using either the applicant's name and/or domain name. Examples of such directory services include business name registrations which record some indication of the business undertaken by the registrant, business telephone directories such as the Yellow Pages, and online directories such as those compiled by Yahoo directory and the Open Directory Project (located at http://www.dmpz.org). The categorisation of the applicant in such third party directories is likely to be consistent with the business undertaken by the applicant and therefore relevant to the goods and services described in trade mark applications made by the applicant. Categorisation keywords can be added to the Keyword List.

H. Digital Certificate Details

Many applicants will be conducting business transactions online. In many cases online transaction security will be provided by using a digital certificate which is compatible with one or more common web browsers. Such digital certificates can be automatically downloaded from an applicant's website and stare the relevant company name. When used in connection with a domain name, digital certificates often store the registrant company name, which may then be used in the methods described above to create the Keyword List.

I. Other Domain Names Hosted on the Same Web Server(s)

It is common for registrants to host multiple domain names on the same set of Web servers or delegate multiple domain names to the same set of nameservers (which servers are responsible for resolution of the domain name to an Internet protocol address). Domain names on the some server or nameservers can be identified using the RNS or the WhoIs database. In some cases, a series of domain names will be used by a registrant in relation to the same business. Where that is the case, each domain name can be used as described above to add keywords to the Keywords List.

J. Other Domain Names Registered by the Same Registrant

The WhoIs database may be analysed to determine other domain names which have been registered by the same registrant. In some cases, a series of domain names will be used by a registrant in relation to the same business. Where that is the case, each domain name can be used as described above to add keywords to the Keywords List.

K. Forwarded Domain Names

Multiple domain names are often registered and forwarded to the same website, both to assist in search engine rankings, and to provide multiple gateways to the same site. For example, a registrant operating a travel business called “Melbourne Travel” might register “mt.com”, “melbournetravel.com” and “melbourne-travel.com” and forward all users access those websites via those domain names to the same Internet website. Such forwarded domain names can be identified using user account details and by querying the DNS and WhoIs. Each such forwarded domain name can be used as described above to add keywords to the Keywords List.

L. Inbound and Outbound Links

Websites often contain hyperlinks to other content which is relevant to that particular website. In the case of business websites, such links are likely to be to further information in relation to the goods and services provided by the business (“outbound links”). Further, other websites may link to a company's websites in order to provide further information or to link to relevant goods and services (“inbound links”). Inbound links to, or outbound links from websites may be analysed to identify additional keywords. For inbound links, the keywords in the text surrounding the link may be added to the Keyword List. Each domain name found may be analysed for keywords using the techniques described in this section.

M. Registered Domain Name Partial Matches

As described above, domain names and company names can often be split into multiple English words. These words can be used to perform a substring search on a database of registered domain names to find additional domains which contain one or more of the words. As described above, domain names are often registered due to their descriptive nature and therefore it is likely that domain names with similar English words will be used in relation to websites relevant to similar goods and services. Where such domain names are identified, each such domain name can be used as described above to add keywords to the Keywords List.

N. Search Engine Matches

The company name, keywords and domain names identified in this section may be submitted to search engines to find the highest ranked search results for those terms. These sites will often be offering the same goods and services as the applicant, and thus each site found may be analysed for keywords using the techniques described in this section.

O. Similar Sites Service

Search engines and web information services such as Alexa offer services which return similar sites (related links) when supplied with a domain name or company name. These sites will often be offering the same goods and services as the applicant, and thus each site found may be analysed for keywords using the techniques described in this section.

P. Patent Registrations

In some cases the applicant for a trade mark will also have granted patents. Such patents are likely to be in relation to the same or similar goods and services as the goods and services for which the trade mark is being applied. Therefore new keywords can be extracted from the patent description, specification and the international classification of the patent.

Q. User Generated Keywords

The end user may be invited, my means of a free form text input area (including a textbox on an Internet web page) to input information about the goods and services which are relevant to the trade mark being applied for. This can either be keywords or natural language describing the goods and services. That information may be added to the Keyword List.

Step 1b—Expansion of Collected Keywords

E. Synonyms, Inflections and Plurals/Singulars

Choice of keywords is very subjective and may result in words that are similar to, but not specifically included in the trade mark application classes. Each keyword can therefore be expanded upon without losing or diluting the intended meaning by collecting synonyms, inflections and plurals/singulars for each keyword and adding those new words to the Keyword List.

F. Spelling Corrections and Common Typing Corrections

Dictionary lookup may occur to determine correct spelling or closest suggestions for each keyword to generate additional keywords. Common typing errors may be substituted to generate additional keywords.

G. Acronym and Abbreviations

An acronym and abbreviations dictionary may be used to expand supplied keywords. For example, the keyword ‘ip’ may be expanded to both ‘Internet protocol’ and ‘intellectual property’.

Step 1c—Ranking or Collected Keywords

As a result of the above steps a Keyword List will be generated. However, because the keywords in the Keyword List are generated using different techniques, the relevance of each keyword may be different. It is therefore desirable to employ a method to minimise the chance of a less relevant keyword from a less reliable source overriding more relevant keywords from more reliable sources without discarding entirely any keywords.

A preferred method for achieving that objective is to assign a ranking to each keyword, which may be any arbitrary thing provided that keywords can be compared with each other (a preferred embodiment having keywords ranked using numbers a to 100 indicating the relevance of the particular keyword to the specification of goods and services, 0 being least relevant and 100 being most relevant).

Rankings can be assigned by each of the methods described above. In addition, each method may have a relevance modifier assigned based on the relevance assigned to results generated by each method. The final relevance of a keyword may therefore be calculated by applying the relevance modifier for the relevant method to the relevance of the keyword assigned by the method. As an example, keywords directly entered by the applicant on an interactive form would be given the highest rating, and the method used would also be given a high weighting leading to a high overall score.

Each of the methods used to collect and rank keywords may perform a number of operations including:

I. Removal or Irrelevant Words

Certain words will be deemed to be so generic as not to contribute to the description of goods and services and therefore should not be included in the Keywords List. If, once the Keyword List has been collected any such words are included, those words will be removed. Examples of such words are “a”, “and”, “the”, “if”, “in”, “including” and “namely”.

J. Keyword Density

When processing content such as the keywords that appear in the text of a website, keywords may be ranked by the number of times they occur on the page or website. For example, it the keyword “engineering” appeared ten times, and the keyword “copyright” appeared once, then “engineering” would be given a higher relevance than “copyright”.

K. Structural Content

When processing content such as the keywords that appear in the text of a website, keywords may be ranked by analysing the structure of the text or mark-up. For example, keywords that appear in the meta-tags, page title, tag clouds or that appear in headings or with larger size fonts would be ranked higher than general text that appears on the page. As an example of a relevance ranking scheme that may be applied:
a. Keywords that appear in page footers (such as copyright messages) may be assigned a low rank;
b. Keywords that appear within content regions generated by third parties (such as advertisement provided by Google), may be given a lower ranking than content generated by the website applicant, but higher than page footers.
c. Keywords that appear within content regions generated by site users (such as blog comments) may be given a lower raking than all other content on the website.

L. Keyword Proximity

When processing content such as the keywords that appear in the text of a website, keywords may be ranked by analysing the proximity of each keyword to keywords which have already achieved a high ranking, such as keywords directly supplied by the applicant. For example, if the user supplied the keyword “credit” and the keywords “card” and “finance” were found in close proximity, the keywords “card” and “finance”would be given a higher ranking than other keywords on the page.

M. Word Type

Keywords may have a relevance modifier based on word type, including adjective, noun, pronoun, verb and adverb. For example, a noun may have a higher relevance modifier than a verb.

N. Exact Match and Partial Match

When website content, or databases are being searched (such as a database at all registered domain names), different relevance may be given to keywords which are an exact match (higher relevance) or a partial match (lower relevance) to the search term. In addition, partial matches that either start with or end with a keyword may be given a higher ranking than a middle-of-the-word match.

O. Domain Name Extension

Domain names are organised into different domain name spaces denoted by the domain name extension. Domain names are often registered in a particular domain name space depending on the activities intended to be undertaken by the registrant. This provides an additional descriptive element to a domain name which it may not have without the domain extension. Some domain name extensions are described as “open” in that they do not have, or have very few, rules in relation to the registration of domain names under them. Other domain spaces are described as “closed” in that they have registration requirements which are relevant to the activities undertaken by the registrant. In most cases, those categorisations are not, of themselves, sufficient to prepare a trade mark application specification. However, mapping the extension against common categories provides additional guidance on which classes may be relevant. An example mapping appears below.

| Domain | |
|---|---|
| space | Likely relevant trade mark class |
| .net | Class 38-Telecommunications |
| .edu | Class 41-Education; providing of training; |
| | entertainment; sporting and cultural activities |
| .tv | Class 38-Telecommunications |
| | Class 41-Education; providing of training; |
| | entertainment; sporting and cultural activities. |
| .int | Class 45-Legal services; security services |
| | for the protection of property and individuals; |
| | personal and social services rendered by |
| | others to meet the needs of individuals. |

Other mappings are also possible. Further, as new, more descriptive domain spaces are released, more mappings will be possible. Each of the keywords for those classes may be added to the Keyword List (or alternatively, the class can be noted as being relevant regardless of the Keyword List).

P. Relevance Weighting of Classes Based on Keyword Frequency in the Existing Trade Mark Database

By recording the number of occurrences in each class of each word used to describe goods and services in existing and lapsed trade mark applications it is possible to determine which class is more likely to be relevant for a particular keyword. For example, “paint” may occur many times in descriptions of goods and services in class 2, but much fewer times in any of the other classes. Therefore the keyword “paint” in a description of goods and services for a new application is more likely intended to be in class 2 than any other class.

In order to implement this process a hash table of each keyword used in goods and services specifications and the classes to which they are relevant is created. Each trade mark specification is examined one word at a time. For each word, a search is undertaken of the entire trade mark database and the number of occurrences of that word in each class is compiled. The search for each word is only undertaken once. Common words such as “a”, “and”, “the”, “including” and “namely” can be ignored. In one embodiment the database is represented by a row for each word identified and a column for each class, optionally columns for each class in different application status could be stored (eg “class 1 registered”, “class 1 pending”, “class 1 lapsed”). Once the hash table is complete, it is then possible for each keyword to determine the most likely class for that particular keyword.

Use of a keyword by a registered trademark in a class can be given greater weight than use of the same keyword in a class by a pending, lapsed application or cancelled trademark, because the status of the trademark may be reflective of a miss-allocation of goods and services in the wrong class.

As different products evolve and terms come in and out of use, the above process can be used to update the relevance of particular classes to each keyword. The process can be executed as frequently as new data is available and separate from the processing of applications and preparation of new specifications.

Keywords can be generated by serial or parallel processes, with a significant processing efficiency in undertaking each of the above in parallel. Further, significant processing efficiencies result from caching of results from previous searches for a particular end user, both across a single session and across different sessions. In one embodiment, keywords can be stored together with the end user's details in a user account.

In a preferred embodiment methods which can be performed in advance will be done in bulk and databases containing the results for later use will be constructed. For example, registered domain names, WhoIs information, digital certificates and web site content may be downloaded and processed in advance for all known domain names and trademark registrations and applications.

In a preferred embodiment, the keyword collection and keyword ranking methods may implement a quality threshold cut-off, meaning that once either a pre-determine number of highly relevant keywords have been collected and/or a pre-defined amount of time has passed, no further keywords will be collected for processing. Such a quality threshold cut-off will further accelerate the performance of the system.

### Step 2a —Collection of Relevant Classes and Specification Terms

The second step is to use the Keyword List generated in Step 1 to derive the recommended terms in each relevant class to create a trade mark specification for the application.

The Nice Convention on Intellectual Property rights defined agreed description of classes between signatory countries (“International classification of Goods and Services”). Such countries include Australia, China, Canada, United States and many countries in Europe. Some countries have their own keyword list which, if used, allows a cheaper application fee. The agreed classification scheme includes many specific goods and services which are intended to be included under each class. The publication is currently in its ninth edition.

One embodiment of this method uses the Nice Convention International Classification of Goods and Services as a source of specification terms and correctly matching those terms to the relevant trade mark classes. A preferred embodiment uses a terns and class database which either limit the specification terms to those which would qualify for a reduced application fee or to expand the specification terms to give each applicant a greater variety of terms to select from. An expanded database in one embodiment comprises aggregated classification terms and classes from some or all of the following resources.
1. The Nice Convention International Classification of Goods and Services;
2. Each of the relevant countries “reduced application fee” classification terms;
3. The terms used by the applicant in previous registrations and/or applications;
4. The terms used by third party applicants which are competitive to the applicant;
5. The terms used by third party applicants which use similar goods and services; and
6. The terms used in each registered trade mark in each relevant country, removing duplicates in the aggregated list.

In processing the Keyword List, and prior to adding the relevant term and class to the draft Specification, optionally each Keyword, term and class can be used as a search term against the relevant terms and classes of all registered and pending trade marks for any relevant jurisdiction. If such search returns a positive match and the relevant trade mark matches the desired trade mark (whether exactly, sounds like or visually), such Keyword, term and/or class can be signalled to the end user (using words or images) as either being “unavailable for registration” or being “unlikely to be accepted for registration”. The keyword can have associated with it a hyperlink which when clicked on provides further information in relation to the registered trade mark or trade mark application which has caused the keyword to be indicated as such. Such availability search can be conducted interactively by the end user as keywords are added in step 1.

The process of matching Keywords, terms and classes in the draft specification to existing registered or pending trade marks can be undertaken in a number of ways, including (either separately or together):
3. “matching availability search”—using a text search of each Keyword, term and class (individually or in different combinations) each match identifies that particular Keyword, term and/or class as being “unavailable for registration” or being “unlikely to be accepted for registration”;
4. “normalisation availability search”—in this alternative, the specification from each registered or pending trade mark is used as a Keyword List for the above process with the result of both the existing registered or pending trade mark and the current application being described in a common set of terms derived from the same terms and classes database. Terms which are not able to be converted into the particular terms and classes database may remain as “free form text”. Once the normalisation is complete, using a text search of each Keyword, term and class (individually or in different combinations) each match identifies that particular keyword, term and/or class as being “unavailable for registration” or being “unlikely to be accepted for registration”. Efficiencies in this process can be obtained from normalising the trade mark specifications in parallel, pre-processing the normalisation of the trade marks database or by only focusing on the particular classes in which the applicant is applying.

In one embodiment applicants may be invited to add entity names (whether a company or individual) and domain names to the keywords. Such names could be at those persons whom the applicant knows is competitive with the applicant or offers the same or similar goods and services as the applicant. From that information, any trade mark applications or registrations for that person (or in the case of a domain name, the registrant of the domain name) can be identified. It is efficient and improves the quality of applications if the applicant can use the same or similar phrases which have already been filed by other applicants in relation to particular classes for the same or similar goods and services.

One implementation would be that for each search term the end user types in, in addition to other suggestions of relevant classes and phrases to add to the specification, a look up can be performed of the existing trade mark database. If the search term matches an existing company name, the user can be asked whether they would like to see what registrations that particular company has. If the user chooses to view those registrations, all phrases used to describe goods and services in registrations of that particular company, regardless of the mark to which they are registered, are displayed to the user, organised by class. Each phrase is divided by the “;” character. The user can then elect to add one or more of those phrases to its own specification in the same class in which the other company has used it.

Step 2b—Ranking of Classification Classes

Each keyword from the Keyword List can be used as a search term on the terms and class database. For each match, the relevant term and the class in which that term appears is added to the draft Specification, or as one embodiment in an interactive interface, may be presented to the applicant as a list of brands which may be selectively added to the draft Specification.

The same operations described above to assign relevance ranking to keywords can be used to provide a relevance ranking to specification terms and classes based on the keywords that appear within those specification terms. Processing steps may include: keyword density; synonyms; acronym expansion; exact and partial keyword matching; word type; plural and singular; structural content; keyword proximity; removal of irrelevant keywords.

To assist the applicant finalise the specification (including for the purposes of allowing the applicant to understand and control costs), the description of goods and services may be displayed in order of ranked relevance rather than numerical or alphabetical order. Different anticipated embodiments include the display order being determined in part or whole by one or more of the following factors:
the sum of the rankings of keyword matches within that particular class—the greater the sum at the rankings the higher the relevance.
the number of overall applications in each particular class during a prior period—the greater number of registrations the greater the relevance.
the number of existing pending and registered trade marks or domain name registrations using the particular keyword existing in a particular class.
the typical classes in which customers of the services are likely to register trade marks—a company specialising in trade mark applications for online services companies is likely to have more applications in class 35 than a company that specialises in trade mark applications for producers of wine.
previous classes in which the applicant has registered trade marks

### Step 3—Creation of the Application Specification

At the end of the above process a complete recommended trade mark specification will be presented to the applicant to review and finalise. The specification satisfies the requirement for valid lodgement at the relevant trade marks office. Finalisation by the applicant may involve reducing the number of classes applied for, removing or adding new keywords to the Keywords List and restarting Step 2 and/or removing/revising the description of goods and services within the classes remaining.

In one preferred embodiment Step 2 is performed in parallel with Step 3, giving the end user an interactive interface (which may be provided via a website) for the preparation of trade mark applications, together with real-time or near real-time feedback on availability keyword and specification term selections.

Once the applicant is satisfied with the specification, the applicant acknowledges it and the application instructions are sent to be processed for lodgement. In same embodiments, processing is automated and via a communications network. In other embodiments, processing may undertaken by a local trade marks attorney, lawyer or other authorised person or may be an administrative representative of the applicant who undertakes the lodgement process on the applicant's behalf.

### Payment

Payment may be effected at any suitable time. In certain preferred embodiments, credit card details are required in order to request a trade mark application. Thus, for example, the credit card details may be provided on the first or second screen viewed by a user and payment effected once the specification is approved in Step 3.

### EXAMPLE 2

### Trade Mark Gap Analysis

In certain embodiments, the present invention provides systems and methods to undertake reviews of trade mark portfolios against the scope of a particular entity's (whether an individual or a company) business activities (“Gap Analysis”).

A company, to take one example, may on a periodic basis undertake a review of its trade mark portfolio to ensure that it continues to cover the changing scope of the business. Such reviews should be undertaken quarterly or annually but rarely are due to the current expense of this process. Those reviews are often undertaken by people skilled in the art as an understanding of both the process for preparing trade mark applications (in order to know what trade marks are registrable), the registration requirements in particular jurisdictions and the particular business is required.

However, using the above described process, such a Gap Analysis can be prepared automatically for example by:
1. Using the persons' name (and/or other nominated applicants) to identify all registered and pending trade mark applications which are relevant to that person by matching that name with the name of the applicant in the relevant trade marks database;
2. Using the persons' name (and/or other nominated applicants) to also identify all registered domain names which are relevant to that person by matching that name with the name of the applicant or registrant in the relevant domain names database;
3. Using Keywords collected as described above based on the persons' name and domain names identified in step 2 as input information to the above process, a draft specification can be prepared for all of that persons' identified business goods and services;
4. The draft specification can then be compared against the specification of each registered or pending mark identified in step 1. This comparison can be done by either:
   a. a “matching availability search” described above; or
   b. a “normalisation availability search” described above,
using the draft specification from step 2 as if it was a new specification and the registered and pending trade marks identified in step 1 as the totality of registered trade marks.
5. Any terms which appear as “available for registration” as a result of step 4 can be reported to the end user as a “gap” in the existing coverage of that persons' trade mark portfolio.

As the above Gap Analysis can be performed automatically, quickly and in a cost effective manner, it is possible, as one preferred embodiment, to use this method to continuously monitor and prepare recommendations to persons responsible for trade mark registrations on desirable additional trade mark applications for a business scope which is changing, without any requirement that person know the scope of the business at any particular time nor the particulars of the trade mark portfolio of the company. Draft trade mark applications can be prepared and presented to the relevant person for completion as described in Step 3 above.

### EXAMPLE 3

### Trade Mark Portfolio Valuation and Registration Class Desirability

It is most likely that a new entrant into a particular industry will provide goods or services which are also provided by other participants in the industry. The above process for preparing suggested trade mark specifications can be used to:
form a view as to the valuation of a trade mark portfolio from the perspective of defensively coveting goods and services which are typically undertaken by competitors;
assist with the identification of gaps in current trade mark portfolio based on competitor's activities; and
identify the most desirable classes in which to have a trade mark registration for a particular industry.

Typically the current method to achieve the above requires a person skilled in the art to review the trade mark register and compare the registrations from each of a number of identified competitive companies. The results of that review are then collated into a report which is provided to the client. That process however relies on a significant number of the competitive companies having a trade mark registration in order to obtain a representative sample of the appropriate scope of competitor trade marks.

Further, even if a significant number of competitive companies have trade mark registrations, such a survey may not result in preferred recommendations, particularly if such competitors were not able to obtain trade mark registrations reflecting their full suite of goods and services (for example, if their name was descriptive and they could only show distinctiveness in one particular classes or on the basis of other existing registrations that while not directly competitive were disallowed by the examiner on “deceptively similar” grounds). Any such results are therefore skewed towards the registrations they were able to obtain. Finally, as trade mark registrations are typically drafted individually, a person skilled in the art of interpreting the scope of trade mark applications is required to compare the scope of the various recorded applications.

A preferred method is to prepare draft specifications for each of the competitive companies using the method described above (using both company name and website as the inputs for generating keywords), resulting in normalised trade mark specifications for each of the competitive companies. Such applications ignore issues of descriptiveness, registerability and other technical issues related to obtaining the registration.

Those draft specifications can then be compared and the most popular classes and specification terms is identified. cl EXAMPLE 4

### Valuation of a Trade Mark Portfolio

Once the most popular classes and specification terms have been identified based on draft specifications generated above, the existing registrations at an entity (individual or company) can be compared to those draft specifications (on the basis of either and/or both class coverage or specification term coverage using either or both a “matching availability search”'and/or “normalisation availability search”). Any classes or specification terms which are not included in the entity's current trade mark portfolio (optionally including trade mark applications) could be, identified as “holes” in the coverage of those portfolio compared with the coverage typically expected in that industry.

Ratings based on the number of such “holes” (calculated using the relevance processes described above) can be assigned to the trade mark portfolio. Such ratings can then be compared to ratings for other trade mark portfolios and used for comparison purposes. In some cases such other trade mark portfolios will have a known value (such as those sold by auction or sold as part of other transactions, whether as part of the same industry or not) and a monetary valuation can be assigned. Alternatively, ratings can be used as a value modifier to determine the appropriate level of discount or premium to be paid for a trade mark portfolio (whether as a stand alone asset or as part of a larger transaction).

### EXAMPLE 5

### Identification of Gaps in Current Trade Mark Portfolio Based on Competitor's Activities and or Industry

Using the above method to value a trade mark portfolio, one result will be a list of classes and/or specification terms which are registered by others in the particular industry but not be the entity. Such gaps can be added to the Gap Analysis described above.

### EXAMPLE 6

### Identify the Most Desirable Classes in Which to Have a Trade Mark Registration for a Particular Industry

By identifying the most popular classes and specification terms as described above, it is possible to determine relevance based on particular industries. This relevance can be used in the processes described above.

### EXAMPLE 7

### Identifying Online Trademark Infringement

A current problem is that “online trademark infringement” search service providers produce a huge number of “hits”—many of which are irrelevant. Some entities, advertise added value by having a human review all results for relevance.

The processes and methods of the present invention can be used to identity websites which are not related to an entity but which are using that entity's brands in relation to the same or similar goods and services. In one implementation, a search is conducted to identify third party websites displaying a particular brand. The websites are analysed to determine which classes of goods or services they are being used in respect of and these are compared to currently pending or registered trade marks held by the brand owner. The output can be a ranked report which sets out a priority list of infringers and optionally with further information about the infringing activity. In some embodiments, the system may assist in generating a cease and desist letter by filling in details based on data obtained from the third party website. In some embodiments, the cease and desist letter is sent automatically, preferably by electronic means, such as email and/or facsimile.

### EXAMPLE 8

### Generating a Keyword Rich Description

The system and processes of the current invention can generate a priority ordered list of keywords relevant to a particular entity or a product or service associated with that entity. This list can be used for search engine optimisation.

### EXAMPLE 9

### Analysing Accuracy of Trade Mark Filings from Website Keywords

The system and processes at the current invention can compare the most important keywords on a website to those actually used in a trade mark application or registration and so provide an analysis and suggestions for improved trade mark filings.

### EXAMPLE 10

### Valuing Trade Mark Protection Based on Ideal Competitor Registrations

It is possible to value protection in particular classes based on the specifications which would be prepared by competitors. For example, consider a new pay-per-click advertising entity looking to register a trade mark. Ideally the entity would wish to know which classes are most “valuable” to obtain registered protection.

One method is to look at the trade mark register and compare the registrations from each of the competitors. However that requires that one's competitors have registered trade marks. And it may not result in the best recommendations, particularly if the competitors were not able to obtain registrations in particular classes (eg, if their brand was descriptive and they could only show distinctiveness in one particular classes) and therefore the results are skewed towards the registrations they were able to obtain. Therefore this method is not the most preferred.

A preferred method is to prepare an applications as if one was the competitive entity, ignoring issues of descriptiveness and then compare each of the prepared applications to see which classes best cover the activities of your competitors. Those classes define the market and will be the most valuable in which to obtain protection, both from existing and new competitors.

By way of example, pay per click advertising entities include: Advantate, ROI, ReachLocal, DirectClicks and HotFrog.

Using the current invention, the relevant classes for each based only on the information contained on each website are as follows:
Advantate—www.advantate.com.au—9, 35, 42, 5, 1, 36, 38
ROI—www.roi.com.au—9, 42, 35, 20, 30, 5, 41
ReachLocal—www.reachlocal:com.au—5, 35, 9, 16, 36, 42, 38
DirectClicks—www.directclicks.com.au—2, 9, 35, 36, 41, 42, 37, 7, 39
HotFrog—www.hotfrog.com.au—43, 35, 16, 9, 18, 39, 45, 5, 11, 30, 42

In graphical format, comparing the number of competitors that each suggested a particular category:

| | | |
|---|---|---|
| 1* | 11* | 35***** |
| 2* | 16** | 36*** |
| 5**** | 18* | 37* |
| 7* | 20* | 38** |
| 9***** | 30** | 39** |
| 41** | 43* | |
| 42***** | 45* | |

Thus, the most valuable classes in which to obtain a registration for any entity who is a competitor for the above companies is: 9, 35, 42

Example goods and services included in those classes which would be relevant:
9—Computer search engine software
35—Pay per click advertising management services; marketing consulting
42—Providing an online website for creating and hosting micro websites for businesses

### EXAMPLE 11

### Competitor Identification and Analysis

The system and processes of the current invention can be used to identify potential competitors based on their use of Keywords within pre-defined categorisations. Further relevant information about them and their strategic intentions can be gathered in useful form, for example based on geography, trade marks filed, business types, keywords on their website or other online places and so on. Thus an entity may for example identify all of its competitors in a particular category of keywords and, for example location.

### EXAMPLE 12

### Category Intensity

The system and processes of the current invention can be used to analyse the intensity of activity of Keywords in a particular category. Thus, for example, it can search for activity based on certain keyword use on websites and/or trade marks and obtain an estimation of potential competitive activity in a category or subset of categories of interest. This information can be matched with other relevant information, such as financial performance of identified competitors in these categories, etc.

### EXAMPLE 13

### Business Identification and Categorisation

The system and processes of the current invention can be used to create a searchable and browseable categorization of the goods and services in relation to websites. For each registered domain name a TM specification can be prepared. From each of those specifications, an interface can be prepared which would allow an end user to search, using any keyword mapping into the categories as described above, for websites. Alternatively, end users could browse the websites using the categorizations (implemented in one embodiment as clickable headings or in another embodiment as a “tag cloud”).

### EXAMPLE 14

### Ranking Keywords Based on Advertiser Competition Within Online Advertising Networks

Keywords can be ranked by reviewing the popularity (alone or as any combination of click through rates, buy rates and price) of those keywords on pay-per-click advertising networks such as Google AdWords.

For example with reference to trademark registrations, a keyword with a higher click through rate would suggest that customers are more likely to characterise the particular brand with reference to that keyword and therefore a trademark registration which includes that keyword would be more valuable than one that does not. That Keyword can then be given a higher ranking.

### EXAMPLE 15

### Marketing Analysis for Domain Name Sellers

The system and method of the invention can be used to undertake a marketing analysis for a domain name seller or reseller. For example, a domain name seller or reseller may wish to obtain a customer segmentation report of the types of entities which purchase domains from them. In such an embodiment, an interface and a server are provided. The interface allows the domain name seller to select the various report parameters (such as a time period, country of origin, top level domain, etc) and request a report. The server may poll a repository of all of the domain name sellers customers and selectively download relevant intonation about them. The repository may be any suitable database or source of information, for example, it may be an internal database held on a server used by the domain name seller, or it may be an external domain name registrar's database. The information downloaded may be of any suitable type and may depend on the parameters and the type of report selected by the user.

Relevant portions at information about each at the domain name sellers customers are then analysed as described herein to identify certain characteristics about the customer. Thus, in some embodiments, a web site located at or associated with a domain name registered by the customer with the domain name seller may be analysed and categorised according to one or more preset categories. Thus, the clients may be categorized according to type of business, types of products and services, size, trade mark classification classes or any other suitable characteristic. The data can then be further analysed to generate insights as to the proportion of clients of a certain size, or in certain industries, or in certain markets and so on. Such a report can then be used by the domain name seller to gain greater insight into things such as its marketing efforts, its customer base and the effectiveness of various marketing campaigns, etc.

In some embodiments a domain name seller may use the system and method of the invention to analyse information about a competitor to gain insight about them. In these embodiments, the same steps are undertaken as just described, with the difference that the competitors customers are identified. This is most likely to be from a publicly available database, but does not have to be.

Similarly, benchmarking reports can be prepared which show comparisons of data across a number of domain name sellers or resellers and overall market segmentation, and other useful marketing analyses.

### EXAMPLE 16

### Marketing Analyses for Services Firms

A service firm may use the system and method of the invention to analyse various characteristics of their customer base, or the applications they file on behalf of clients. Such applications may be of any suitable type, for example they may be intellectual property right applications (such as for trade marks, patents, registered designs, etc), or business names or for company incorporations, or litigation conducted, or licences or any suitable form of application.

Indeed, competitor analyses and benchmarking analyses may also be undertaken in order to compare a plurality of service firms and/or benchmark them and to provide insight into the market.

As an example, this aspect of the invention may be applied to an intellectual property service firm. According to these embodiments, an intellectual property database is chosen for example by selecting a country, type of intellectual property, etc.) and further parameters are selected (for example trade marks in certain classes, or patents in certain classifications, the name of the intellectual property rights owners for whom the intellectual property firm acts, etc) and one or more intellectual property service firms are selected for analysis.

The server then polls the relevant database for the selected information which is then analysed according to the present invention. Thus, in some embodiments a list of names of entities which have used the services of each intellectual property service firm is generated from the intellectual property rights database. As an example, this dataset may have the following characteristics:

| | |
|---|---|
| Database | USPTO Trade Marks |
| Classification | Class 9 |
| Date | 1 Jan. 2008 to 1 Jan. 2009 |
| Parameter 1 | List Assignees of all trademarks |
| Parameter 2 | Representative firm = Alpha, Beta and Delta LLP |

Thus, a list will be generated of all clients for which the firm Alpha, Beta and Delta LLP filed trademark applications at the USPTO in class 9 between 1 Jan. 2008 and 1 Jan. 2009.

This list may then be analysed according to the methods and system of the invention to identity characteristics associated with the clients. Thus, the clients may be categorized according to type of business, types of products and services, size, or any other suitable characteristic. The data can then be further analysed to generate insights as to the proportion of clients of a certain size, or in certain industries, or in certain markets and so on. The firms can be compared based on their client bases and other market relevant insights can be gained.

### Virtual Assistant System and Method

A user browsing a website for particular content such as information relating to a particular product or service may in some instances require assistance. Accordingly in a separate aspect of the invention, there is provided a virtual assistant system and method capable of providing real time assistance to a web site user. The assistance is provided in real time and can be provided by automated prompts in response to actions (such as clicking buttons or keystrokes or certain commands) or by a real person using a virtual assistant interface or a combination or both.

The system comprises a client interface for use by the web site user, a client interface server, a remote management interface for use by a person managing the virtual assistant system, and a remote management interface server. The client interlace and remote management interfaces may for example be rendered as Internet websites viewable in web browsers. The client interface exchanges information with the client interface server. Any suitable information may be exchanged, for example such things as IP address of the client computer, a unique identifier for the user's session, information regarding how the user came to the system—for example, through a particular sales channel or series of web pages and the session state, the physical location of the user, the browsing history of the user, other information associated with the user, such as domain name, trade mark, web site, shopping history, socioeconomic categorization, consumer categorization, marketing categorization, information from publicly available databases or websites such as social networking sites, or any other information.

In order to update the session information, the client interface communicates regularly and/or only when session information changes with the client interface server. In addition to session information, the client interface also communicates to the client interface server the actions of the user, such as search terms, keywords, rankings, pages browsed, hyperlinks clicked, and so on. Each of those things may be entered manually by the client, or determined by the system through a number of different inputs. For example, if the client interface derives a website address as a search term, that address together with the keywords obtained from the relevant website may be communicated to the server (whether by the client interface, a different physical or logical server which is involved in the operation or the system).

Certain information is relayed from the client interface server to the remote management interface server. This may comprise some or all of the information relayed to the client interface server from the client interface. In some embodiments the client interface server and the remote management interface server are the same server. However, they may equally be separate, and or various functions carried out by each server described herein may be carried out on a plurality of servers. The client may be browsing a website located on a first server from which information is passed to a client interface server and which may communicate with a third server—the remote management interface server. In some embodiments one or more of these servers may be combined or functions may be distributed across any number of servers.

The information communicated to the server can be varied depending on the intended use of the information. Thus for example the amount and type of information may be varied. There may be more than one client interface and more than one remote management console. In some embodiments, a second level of management console is used in order to assist a user of a management console. This may for example be used during ‘real time’ training of a management console user, or by a support person providing higher level support to the client and thus monitoring and engaging with the support provided by the original management console user.

The remote management interface polls the server and displays the information held by the server relating to a client session in a suitable format intended for the particular use at hand. For example information may be aggregated (for example, current number of active users) or displayed an a per user basis (for example, that pertaining to a particular user at a particular time), or categorized based on an indicator of relative interest of the client in various browsed content, or any other suitable format. The remote management interface may receive information which has ultimately arisen from the client's browser in real time. This may be achieved in a number of ways. For example, there may be a very high frequency of polling by the remote management interface server, or the remote management interface server may be notified each time there is a change to the session in use by the user. These real time embodiments provide added advantages as the remote manager can readily keep up with the browsing and associated queries of the user.

With that information, a user of the remote management console can, whether in consultation with the user (via a text chat window, telephone, VOIP, video or any other suitable medium) or independently of the client (whether this is visible to the client or not), modify the session information (including search terms, keywords, or rankings), with the result of such modifications being displayed to the client in the client interface. The ability to remotely change the session information of the user's session is a particularly useful aspect of some embodiments. This aspect enables the person acting as virtual assistant to more readily provide useful assistance to the user. Thus, hyperlinks can be clicked, products or services can be placed in virtual shopping carts, new or more relevant web pages can be displayed, and so on. Such a feature enables the user to experience a more personal and useful browsing and/or shopping experience. This is distinct from some prior art systems in which the user is sent a link or information about steps to take in order to undertake one or more at these actions. In the present embodiment of this aspect of the invention, these actions are taken for the user and remotely.

In some embodiments of the invention, the means of communication is provided in a readily accessible form in association with the client interface. Thus, for example, a chat area may be presented on a web page being browsed by a client, or a video chat area may be so provided, and so on. In some embodiments, the communications area is embedded in the website being browsed and is not a popup window.

As one example implementation of this aspect of the invention, a user may be browsing a website looking for a particular product, such as a particular brand and style of shoes. The user may be searching for some time, or continue to cycle back to a particular page, or a particular page may be displayed for a long period of time or there may be some other signal which creates an alert on the remote management console that help may be required by that particular user. Equally, though the user may request help, for example by clicking a ‘get help’ or ‘virtual assistant’ button. In some embodiments, users are notified when they land on a website incorporating the technology of the invention that they will be assigned a virtual assistant who will monitor their progress and assist where necessary. In these embodiments, the virtual assistant may introduce themselves as the user lands on the website to be polite, or they may stay out of the way until called upon for assistance. It will be appreciated that there will be other suitable ways in which to commence the provision of assistance by a virtual assistant according to the invention.

In this particular example, if the user is unable to find what they are looking for, the person operating the remote management console may enter a command (for example by clicking a button or entering text) which causes a chat area to open on the user's browser. The remote manager may then ask whether assistance is required or enter some similar query. In the current example, the remote manager may suggest a particular search term for the user to try in the search area on the website they are browsing. Equally, the remote manager may inject the search term into the search area on the website that the user is browsing. This may be done with full visibility for the user or otherwise. The user may then see the results of this search. If the user still can not find what he or she is looking for, the remote manager may for example enter a URL for a page which he or she considers will contain the answer or contain the content that the user is looking for. In this situation, the URL is again injected into the browser of the user so that the web page corresponding to this URL is then displayed to the user. Any other suitable command may be thus injected by the remote manager in this way.

In some preferred embodiments, the remote management console is set up so as to enable any suitable command to be entered by the remote manager and thus injected into the user's web page. The commands may be entered using text or by clicking buttons, or in any other suitable way. They may for example include:
{search:red shoes}—adds the term “red shoes” into the search box with a nice animation.
{alert:Mike can you please phone me back}—would show a modal alert with that message.
{redirect:http://www.abc.net.au}—would redirect the web browser to the abc website.
{popup:http://www.abc.net.au}—would open the abc website in a separate window.
{addcart:barcode#128761726}—would add the product with barcode 128761726 to the user's shopping cart.

{Chat:}—would open a chat window on the user's browser

{Select item:Oxford Dictionary}—selects the item with the name ‘Oxford Dictionary’ from amongst other items in a list

In some embodiments in which the website of interest comprises a form to be filled the remote manager may enter relevant details in the form and then inject them into the form being displayed on the user's browser.

Once the user has found an item of interest, they may then have further questions which can be answered by the remote manager and further commands may also be injected. If the customer has found a product or service to purchase, the remote manager may offer to add it to the user's shopping cart and assist with the various steps of checking out selecting delivery and paying for the item. Again, in each instance, the remote manager may inject the relevant command directly into the user's browser.

In some aspects of the invention is adapted to function as a virtual shop assistant. The system and method comprises a user interface for a person browsing an Internet site and a remote management interface. These interfaces may be housed on the same or on different servers.

In some embodiments, this aspect of the invention is implemented in respect of individual web pages which can be browsed by users by inserting code in the web page. The code may of course also be inserted in an area which is common to all pages oh a web site, such as a header, or footer etc, Thus in these embodiments, only web pages with the requisite code may take advantage of this aspect of the invention.

In other embodiments, a portal is provided within which users may browse web pages of interest. The portal provides the functionality to allow the remote manager to inject commands into the user's browser etc. In these embodiments, the remote manager may act as a virtual assistant and may accompany the user while browsing, for example on a virtual shopping tour, while looking for vacation destinations, while undertaking research on a topic, and so on.

### EXAMPLE 17

### Interactive Remote Monitoring and Assistance with Preparation of Trade Mark Applications

Example 17 describes an example implementation of the virtual assistant system and method described herein.

A client in attempting to categorise a brand would benefit in some cases from the assistance in the process of a third party in choosing, ranking or modifying keywords and the categories to which those keywords relate. In many cases it is not practical nor desirable for the client and third party to be in the same location, and such an arrangement may suffer from the same or similar issues as if the client was to attend a session with a third party service provide (such as a lawyer).

In this example, the system comprises a client interface server and remote management interface server. The client interface and remote management interfaces can be rendered as Internet websites viewable in web browsers. The client interface exchanges information with the client interface server. Any suitable information may be exchanged, for example such things as IP address of the client, a unique identifier for the client session, information regarding how the client came to the system—for example, through a particular sales channel or series of web pages and the session state, the location of the client, the browsing history of the client, other information associated with the client, such as domain name, trade mark, web site, or other information.

In order to update the session information, the client interface communicates regularly and/or only when session information changes with the client interface server. In addition to session information, the client interface also communicates to the server the search terms, keywords, rankings and the actions of the client in relation to those things. Each of those things may be entered manually by the client, or determined by the system through a number of different inputs. For example, if the client interface derives a website address as a search term, that address together with the keywords obtained from the relevant website may be communicated to the server (whether by the client interface, a different physical or logical server which is involved in the operation of the system).

The information communicated to the server can be varied depending on the intended use of the information. Thus for example the amount and type of information may be varied. There may be more than one client interface and more than one remote management console. In some embodiments, a second level of management console is used in order to assist a user of a management console. This may for example be used during ‘real time’ training of a management console user, or by a support person providing higher level support to the client and thus monitoring and engaging with the support provided by the original management console user.

The remote management interface polls the server and displays the information held by the server relating to client session in a suitable format, for example aggregated (for example, current number of active users) and per client (for example, the particular keywords being considered by a client at a particular time).

With that information, a user of the remote management console can, whether in consultation with the client (via a text chat window, telephone, VOIP, video or any other suitable medium) or independently of the client (whether this is visible to the client or not), modify the session information (including search terms, keywords, or rankings), with the result of such modifications being displayed to the client in the client interface.

As one example implementation of this system, a client looking to register a trade mark application may use the system to gather keywords which are relevant to the client's particular application. Once those keywords had been collected, if the session information appeared such that the client was confused about the next step in the process, was unable to locate a particular specification term relevant to their business, was about to leave or had left the application without it being completed, or the client had notified that they wished to receive assistance, the user of the remote management console may interact with both the client and the client's application by suggesting search terms, keywords or rankings to overcome the client's issues.

As another implementation, a user of the remote management console may send to the client a Internet URL to a suggested trade mark application which had been prepared by the user or the remote management console (whether based on the client's domain name or other information above or interactively in discussion with the client). Together the client and the user of the remote management console may then finalise the application.

### EXAMPLE 18

### Entity or Person Profiler

The system and method of the present invention may be used to prepare a profile of a particular entity or person. By entering the person or entity's name in the search box, a priority ordered data set can be generated according to certain predetermined categories of information and according to a predetermined priority order. Thus, relevant information about a person or company can be quickly compiled from relevant information sources, including websites associated with that person or entity, prioritised and displayed in a useable format, for example for comparison.

### EXAMPLE 18

### Brand Availability Search

The system and method of the present invention may be used to prepare a more detailed brand availability search and recommendation than is typically available on an automated basis using conventional techniques. For example, the end user is asked for the brand they want to use and the goods and/or services they want to use it for. In this example, the end user might type “Red” for the brand and “shoes” for the goods and/or services. The system would then prepare a trademark specification based on the information provided by the user. A search of the trademarks database for the word “red” would identity a large number of matches. The classes at each registration (whether as they appear or normalised as described above) is then compared to the end users desired brand. Appropriate information is provided to the end-user regarding the fact that there are many matches for the word “red” and whether any of those matches are for shoes or within the same category as “shoes”. Likewise, searches of domain name registrations for “red.com”, “redshoes.com” and other variations in different domain spaces is undertaken. Each registered website is categorised and compared to the categorisation of the end-users brand. Likewise for company registrations and any other brand related registrations. All information is compiled together in a report and presented to the end-user. Optionally, registration services can be offered where the relevant name is available for registration.

1. A method for generating a keyword about a brand comprising: receiving at least one element of basic data and using the basic data to generate a keyword.

2. A method for categorising a brand comprising:
a. collecting a keyword;
b. optionally expanding the collected keyword;
c. optionally ranking the collected keyword against another collected keyword;
d. collecting a category relevant to the keyword;
e. optionally ranking the category against another relevant category;

3. A method for creating an application comprising the method according to claim 1 or claim 2 and optionally the step of creating an at least partially filled form or document.

4. A method for filling a form or creating a document comprising a method according to claim 1 and/or claim 2.

5. A method for preparing an application for protection of a brand comprising a method according to claim 1 and/or claim 2.

6. A method of performing a brand protection gap analysis comprising a method according to claim 1 and/or claim 2.

7. A method for valuing one or more brands comprising a method according to claim 1 and/or claim 2.

8. A method for analysing a brand protection strategy comprising a method according to claim 1 and/or claim 2.

9. A method for identifying a desirable brand protection strategy comprising a method according to claim 1 and/or claim 2.

10. A method for identifying brand misuse comprising a method according to claim 1 and/or claim 2.

11. A method for identifying and optionally analysing a competitor entity comprising a method according to claim 1 and/or claim 2.

12. A method for ranking keywords based on advertiser competition within online advertising networks comprising a method according to claim 1 and/ or claim 2.

13. A marketing analysis method for a service provider comprising a method according to claim 1 and/or claim 2.

14. A method for collecting information for the selection of a Nice classification for a trade mark application comprising the step of collecting data relevant to the trade mark applicant from a publicly available source of information.

15. A method for categorizing a brand comprising a method according to claim 1 and/or claim 2.

16. A method for generating a keyword rich description comprising a method according to claim 1 and/or claim 2.

17. A method for profiling an entity or person comprising a method according to claim 1 and/or claim 2.

18. A method for analysing brand availability comprising a method according to claim 1 and/or claim 2.

19. A virtual assistant method comprising interactive remote monitoring and optionally comprising assistance with use of a website.

20. A method for attracting an online trade mark application comprising providing a trade mark application interface in parallel with a domain name application or registration interface.

21. A system for generating a keyword about a brand comprising: an interface to allow a user to submit basic data; hardware and software to receive and optionally store basic data; and processing hardware to generate a keyword from the basic data.

22. Instructions stored on a computer readable medium, the instructions for a process for generating a keyword about a brand comprising: instructions in relation to receiving at least one element of basic data; and instructions in relation to using the basic data to generate a keyword.
